(19) United States
(12) Patent Application Publication
(10) Pub. No.: US 2006/0086741 A1
(43) Pub. Date: Apr. 27, 2006

(54) Low temperature/cryogenic liquid storage structure

(75) Inventors: Ned A. Bacon, Naperville, IL (US); J. Ricky Simmons, Aurora, IL (US); Dale A. Swanson, Aurora, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CHICAGO BRIDGE & IRON COMPANY

(21) Appl. No.: 10/970,333

(22) Filed: Oct. 21, 2004

(51) Int. Cl. F17C 13/00

(52) U.S. Cl. 220/560.12

(57) ABSTRACT

A low-temperature/cryogenic liquid-storage structure has an inner tank liner made of conventional low-temperature/cryogenic tank-quality plates with structural members that provide flexibility. The plates are mounted on connectors that accommodate movement of the liner with respect to the bearing wall. The plates have a thickness of between 1/16″ and ½″ and a surface area of at least 100 square feet. The structural members are conventional construction materials that have a wall thickness of more than 1/16″. Load-bearing insulation extends between the outer surface of the inner tank liner and the inner surface of an outer bearing wall that is impervious to vapor.

### CROSS-REFERENCE TO RELATED APPLICATIONS

Not applicable.

### STATEMENT REGARDING FEDERALLY-SPONSORED RESEARCH OR DEVELOPMENT

Not applicable.

### REFERENCE TO A COMPACT DISK APPENDIX

Not applicable.

### BACKGROUND OF THE INVENTION

The present invention relates generally to large-scale liquid storage structures and particularly to structures used for storing low-temperature or cryogenic liquids, such as liquefied natural gas (LNG), which is transported and frequently stored at temperatures around −261 F (−163 C). Other gases commonly stored in liquid phase below ambient temperatures include ammonia, propane, butane, LPG, and ethylene, and also oxygen, argon, nitrogen, hydrogen, and helium. LNG terminal storage tanks are generally field-erected vessels in sizes of 315,000 to 1,000,000 barrels (50,000 to 160,000 cubic meters).

The structures can be found in many places. Free-standing tanks can be found wherever large-scale liquid storage is needed. Tanks can also be built into openings in the ground or inside ships. Gravity-based structures (GBS) with integral storage capacity can be installed offshore on the sea floor.

A form of secondary containment is not uncommon in these structures. Gravity-based storage structures and full-containment free-standing tanks for storing liquefied natural gas commonly have an outer concrete containment wall. A liquid or vapor barrier on the inside surface of a concrete containment wall can provide secondary containment in the event of a leak in the inner tank, and can prevent outside moisture from penetrating the insulation. Similar vapor barrier and containment system concepts are used for in-ground tanks and ship tanks.

Free-standing tanks are often made with an inner tank made of stainless steel, aluminum, 9% nickel steel, or other materials suitable for low-temperature or cryogenic service. To reduce heat transfer, the inner tank is usually spaced away from the inside surface of the containment wall, leaving room for thermal insulation. To withstand the static and dynamic pressures of the stored liquid, the tanks in free-standing structures are often made of metal plates having a thickness ranging to as much as 2″.

As described in U.S. Pat. No. 4,366,917, integrated storage structures can be built using a thin-gauge inner membrane and load-bearing insulation. The load-bearing insulation can be used to transmit the static and dynamic forces on the membrane to the containment wall, which then serves as a bearing wall to structurally contain the liquid. This allows the membrane to be made significantly thinner and lighter than a traditional inner tank. There are, however, problems associated with such designs.

Integrated storage structures must accommodate the dimensional changes that occur in the membrane as temperatures change when filling or emptying the structure. This problem has been addressed by using a very thin membrane (less than about 1/16″) and providing it with crimps or corrugations that accommodate the dimensional changes. Although some forms of crimps or corrugations are illustrated in U.S. Pat. Nos. 4,021,982 and 4,461,398, the only way of providing such crimps or corrugations for which the inventors have seen commercial acceptance has been in the production of shop-produced prefabricated sheets specified by the French company Technigaz.

Technigaz sheets are believed to be provided in small sizes, commonly panels from approximately 2 or 3 feet (0.5 to 1 m) square up to about 11′3″×4′7″ (3.4 m×1.4 m). The small size of these panels, which are shop-produced off-site, facilitates handling. The panels incorporate a grid of orthogonal corrugations that sometimes have a square pitch of 27″×27″ (680×680 mm). The corrugations act as a bellows, allowing the contraction/expansion of the panels in two directions under thermal cycling. These two-directional corrugations can be readily made and can function well in gauge-thickness austenitic stainless steel. Technigaz panels can be made of 1.2 mm thick austenitic stainless steel, corresponding to ASTM A240 type 304 (or X5CrNi 18-10 under European standard NF EN 10088-2[1.4301]/1995). The required corrugations may be more difficult to form if the panel were made of a thicker material, or more prone to failure if a less ductile material, such as less-expensive aluminum or 9% nickel steel, were used.

To form the internal membrane, the Technigaz panels are generally welded together with lap fillet welds. Closely-spaced dedicated stainless steel anchoring pieces set in the underlying load-bearing insulation provide points for anchoring the stainless steel sheets.

Concerns about leaks through the thin panels or through the extensive welding required to form the entirety of the inner tank membrane are addressed by bonding an additional liquid barrier of ultra-thin film such as Permaglass between the membrane and the insulation. In addition, leak detection equipment is often provided in the space between the thin membrane and the bearing wall.

### BRIEF SUMMARY OF THE INVENTION

The inventors have developed an integrated low-temperature/cryogenic structure that is simpler to build and more robust than previously-used membrane designs. The increased durability may reduce any need for an additional liquid barrier or additional drainage equipment like those used in Technigaz systems.

While there are some similarities to previous membrane systems, there are also significant differences. Like conventional membrane systems, the new structure includes an outer bearing wall that is impervious to vapor, and load-bearing insulation extending between the outer surface of an inner liquid barrier and the inner surface of the outer bearing wall. However, the inner liquid barrier—an inner liner—is significantly different than either conventional free-standing inner tanks or conventional inner membranes.

The new inner liner can be made of conventional low-temperature or cryogenic plates that are significantly more durable than the thin-gauge inner panels used in known membrane systems, but thinner than the plates traditionally used for free-standing inner tanks. Specifically, the new structure can be made with conventional tank-quality metal plates, such as 8′-wide plates having a thickness of between 1/16″ and ½″. The use of these plates can reduce the costs compared to a conventional free-standing inner tank.

The walls of the new inner liner contain structural members that provide flexibility for expansion/contraction. These members can be made from common, off-the-shelf type construction materials such as pipes, tubing, or structural shapes. These members can provide the necessary flexibility to accommodate thermally-induced dimensional changes in the liner, while allowing the structure walls to be constructed without the need for special, off-site fabrication.

The use of larger-scale components than used in typical membrane systems can also provide additional advantages. Using larger plates can mean that significantly less welding will be required than is commonly needed with a membrane, and the liner can be built using more robust butt-welding techniques common to the tank-building industry. In addition, since construction of inner tanks is generally on the critical path for typical LNG tank construction, a reduction in the required welding may reduce the overall schedule and provide more flexibility in construction sequencing. The thicker plates and flexible structural members are also less prone to damage under normal construction conditions. Since a greater range of materials can be used to build the structure, there is also a possibility of savings in materials selection.

### BRIEF DESCRIPTION OF THE DRAWINGS

The invention may be better understood by referring to the accompanying drawings, in which:

FIG. 1 is a partial isometric view of a liquid-storage structure in accordance with one embodiment of the present invention;

FIG. 2 is a similar view of another embodiment of a structure in accordance with the invention;

FIG. 3 is an enlarged fragmentary perspective view of the structure seen in FIG. 1;

FIG. 4 is an enlarged view of a sliding connector seen in FIG. 3;

FIG. 5 is an enlarged elevational cross-section of the lower corner of the structure seen in FIG. 1;

FIG. 6 is a partial elevational cross-section of the structure seen in FIG. 1; and

FIG. 7 is a plan-view cross-section of the structure seen in FIG. 1.

### DETAILED DESCRIPTION OF THE INVENTION

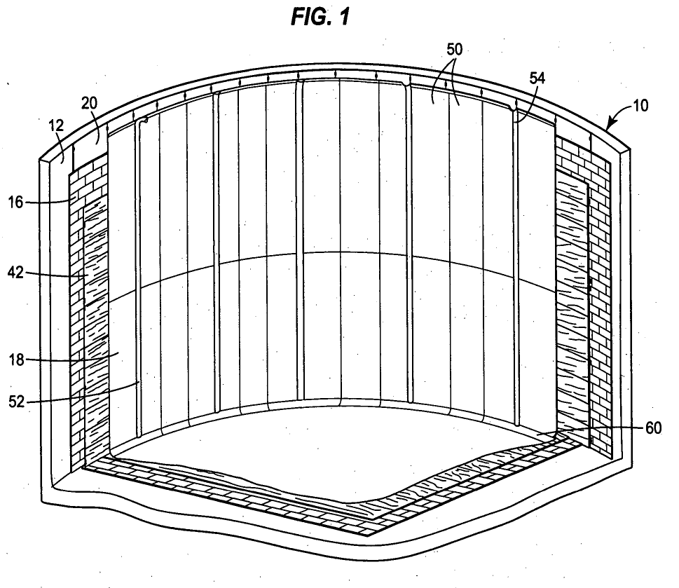

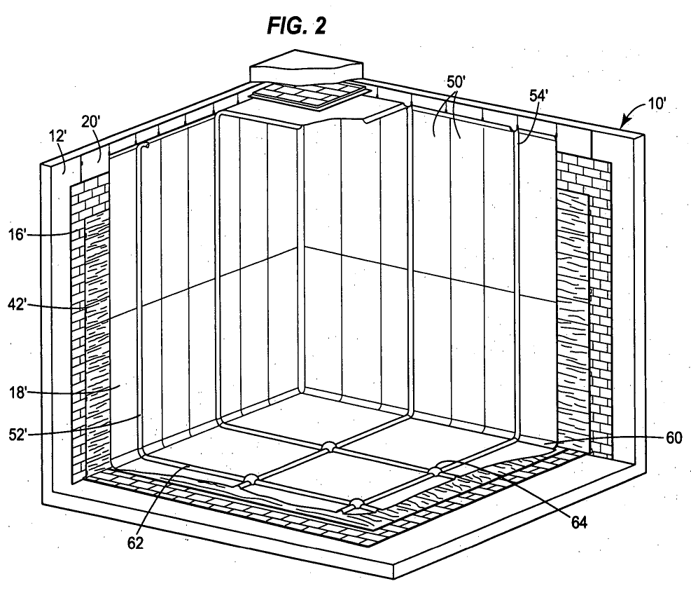

FIG. 1 shows one embodiment of a low-temperature/cryogenic liquid-storage structure 10 that can be used to store liquefied natural gas (LNG) or other liquids at low/cryogenic temperatures (that is, temperatures of 40 degrees F. or lower). The illustrated structure is a free-standing tank. FIG. 2 shows a similar gravity-based structure 10′ that could be used for storing LNG offshore. The invention might also be used with in-ground tanks and ship tanks.

The sides of each illustrated structure 10, 10′ include four basic components: an outer bearing wall 12, 12′, a connection system, load-bearing insulation 16, 16′, and an inner tank liner 18, 18′. Each will be discussed in turn.

The Outer Bearing Wall

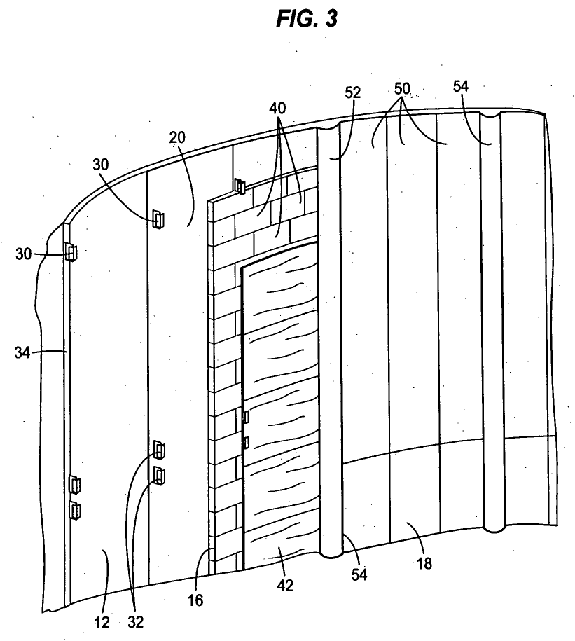

The illustrated outer bearing wall 12 in the structure 10 seen in FIG. 1 and in more detail in FIG. 3 is a conventional reinforced concrete wall, 60 to 140 feet tall and 20-36″ thick, with a 100-300 foot diameter. A 3-5 mm thick carbon steel liner 20 on the inside surface of the outer bearing wall serves as a vapor barrier, preventing outside liquids or vapors from penetrating the wall and also providing secondary containment in the event of leaks in the inner tank liner 18. Other materials, such as cryogenic steel, polymeric sheeting, or a trowel-on or spray-on polymeric coating can also be used to provide vapor resistance on concrete or other porous walls.

Other arrangements of the outer bearing wall 12 are also possible. For in-ground tanks, the rock face might be used as the outer bearing wall. It may be preferred, however, to provide a smooth concrete or metal surface. In ships, the ship hull or superstructure might be used as the outer bearing wall. In many cases, the outer bearing wall could be made of steel. Where the outer bearing wall is made of steel or is otherwise impervious to vapor, then the use of an additional vapor barrier may be unnecessary.

The Connection System

In the illustrated embodiments of the invention, connectors 30, 32 are attached to embedments 34 in the outer bearing wall 12 to provide anchoring points for the insulation 16 and for the tank liner 18. The illustrated connectors include fixed anchors 30 at the top of the wall and sliding connectors 32 below the top of the wall. Flexible connectors could also be used in place of sliding connectors. Alternatively, fixed anchors might be provided at mid-height of the walls, with sliding or flexible connectors used near the top and bottom of the walls.

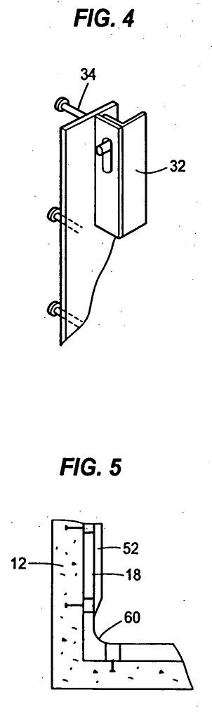

The sliding connectors 32, seen in more detail in FIG. 4, use a slide arrangement on structural members. The sliding arrangement provides a freedom of movement in the vertical direction. This freedom of movement accommodates vertical expansion or contraction of the tank liner 18 with respect to the bearing wall 12. Ultimately, the purpose of the connectors 30, 32 is to control the direction of expansion/contraction of the tank liner, and to assure that movement is transferred smoothly and appropriately. Other arrangements and configurations of the connectors may be used to address these issues.

The illustrated connectors 30, 32 are made of steel. Since steel can provide a thermal conductive path through the insulation, it is preferable to minimize heat transfer through these connectors. This can be done by 1) reducing the overall number of connectors, and 2) reducing the heat transfer through each individual connector. Heat transfer through an individual connector can be reduced by providing a thermal break in the connector, or by reducing the cross-sectional area of thermally-conducting steel in each connector. The illustrated structures include only one connector for every 100 square feet or so of wall area, much fewer than in previously-known membrane designs.

The Load-Bearing Insulation

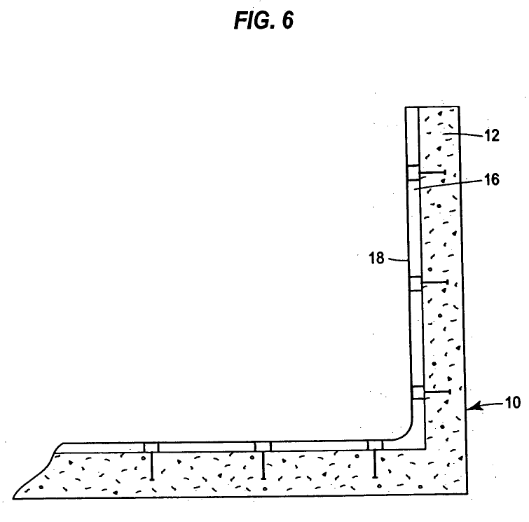

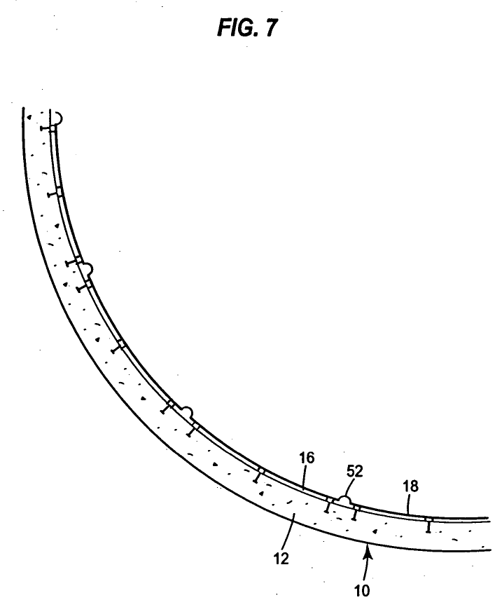

As seen in FIGS. 1, 3, 6, and 7, the illustrated structure 10 has load-bearing insulation 16 between the outer bearing wall 12 and the tank liner 18. The illustrated insulation is in the form of conventional 6-18″ thick cellular glass blocks 40 (such as Foamglast™ blocks available from Pittsburgh Corning Corporation of Pittsburgh, Pa.) covered by plywood 42 or some other protective wear layer. The illustrated blocks and plywood can be held in place by conventional adhesive known in the industry, or by mechanical connectors. A strip of a non-flammable tape or other material may be applied behind the intended weld joints to protect the wear layer from being burned during welding of the liner.

Other types and thicknesses of insulation 16 can also be used. The illustrated form of insulation can be adequate to reduce thermal transfer between low-temperature/cryogenic liquid and an ambient environment. The thickness of insulation can be varied as needed to provide the desired level of overall heat leak. The insulation can also take other forms; for example, it can take the form of PUF or PVC foam panels. The intent is that the load-bearing insulation layer be sufficiently resistant in compression to effectively transfer the static and dynamic pressures from the stored liquid to the outer bearing wall 12.

The Inner Tank Liner

The illustrated inner tank liner 18 can be built by common tradesmen, with conventional off-the-shelf type construction materials, using conventional tank construction methods. The fact that the tank liner can be constructed in this way may provide important advantages over more-specialized membrane systems.

The illustrated tank liner 18 is made primarily of commonly-available low-temperature/cryogenic metal liner plates 50 that are welded or mechanically attached to the connectors 30, 32 on the bearing wall 12. The liner plates shown here are common tank-quality 8′×30′ or 8′×40′, 5/16″ thick stainless steel plates.

Other common metal plates used in tank construction could also be used to build the tank liner 18. In addition to stainless steel, aluminum or 9% nickel steel could be used. The relatively-large size of these liner plates 50 (with a surface area greater than 100 square feet) reduces the linear footage of welding needed to build the liner. The thickness of these plates, which can range from 1/16″ to ½″ or more, facilitates the use of full-thickness butt welding instead of lap fillet welding, providing better endurance for flexing and load/deflection behavior of the liner/liner containment system. Full-thickness butt welding can be subjected to more thorough NDE and is less subject to leaking than lap fillet welding. Use of thicker plates than in conventional membranes also provides greater confidence in the quality and durability of the product: a leak-detection system is not necessary.

On the other hand, because the liner plates 50 are supported by the outer bearing wall 12, they can be thinner (and thus less expensive) than the kind of plates commonly used at the base of free-standing tanks.

To accommodate dimensional changes in the tank liner 18 during filling or after emptying of the structure 10, 10′, structural members 52 are used in the walls to provide lateral flexibility. The illustrated “flexible” structural members are standard 18″ diameter, schedule 10S half-pipe sections with a wall thickness of 3/16″. The sides of the illustrated half-pipe sections are groove welded to vertical edges 54 of the adjacent liner plates 50.

Other common structural members 52 can also be used to provide the required flexibility in the liner 18. For example, sections of pipe or tubing, or structural shapes such as angles might also be used. A wall thickness of more than a 1/16″ may be desirable for its ease of welding and robustness: such members hold up better than members made of thinner material.

Relatively large sizing of the structural members may permit each individual member to accommodate more lateral movement, reducing the number of these members that are needed in the structure and increasing the spacing between them. The illustrated members 52 can accommodate significantly more range of motion than the kinds of crimps used in conventional membranes, and thus can accommodate the full range of thermal lateral movement in 8′-wide liner plates. In fact, the illustrated structural members can provide up to approximately 2″ of lateral flexibility. Consequently, in the circular-walled tank embodiment of the invention seen in FIG. 1, these structural members need only be used between every third liner plate 50, at approximately 24′ arcs. In the flat-walled, GBS embodiment of the invention seen in FIG. 2, these half pipe members are also disposed between every third liner plate 50′, again approximately 24′ apart. Other spacings of the flexible structural members may of course be used in other situations.

Although the required thickness of the liner plates 50 may effectively preclude the kind of specialized, two-directional crimping used in conventional membrane panels, the formation of integral one-directional structural members in the liner plates may be possible. For example, the illustrated structural members 52 (or other simple shapes providing lateral flexibility) can sometimes be bent or rolled into one of the vertical edges of a liner plate, or into a middle section of the plate. Forming the structural members into the liner plates may be more feasible when fewer structural members are required; that is, when the structural members are spaced farther apart than the relatively closely-spaced crimps in a conventional membrane.

While the illustrated arrangement of common tank-quality liner plates 50 and “flexible” structural members 52 can accommodate circumferential expansion/contraction of the inner tank liner 18, conventional construction details can be used to accommodate vertical expansion or contraction of the liner. For example, variations of a flexible “thermal corner” detail, such as the one seen in FIG. 5, can be used at the lower corner of a free-standing tank or GBS. The illustrated thermal corner detail includes a curved knuckle 60 that transitions from the liner walls to the floor, and is strong enough to support the liquid load in the structure while flexible enough to accommodate thermal movement. For tanks up to about 140′ tall, such thermal corners may provide all the flexibility in the vertical direction that is needed in the liner.

Use of flexible structural members 52 need not be limited to the walls of the structure 10, 10′. For tanks taller than about 140′, a transversely-mounted flexible structural member can be used between courses of vessel plates to provide additional flexibility in the vertical direction. Similar members can also be used in roofs or floors. FIG. 2 illustrates the use of flexible structural members in the floor of a GBS. In that illustration, the structural members 62 in the floor are arranged to be continuous with the structural members 52′ in the walls. Where necessary, special multi-directional flexible units 64 may be useful where structural members intersect.

This description of various embodiments of the invention has been provided for illustrative purposes. Revisions or modifications may be apparent to those of ordinary skill in the art without departing from the invention. The full scope of the invention is set forth in the following claims.

What is claimed is:

1. A low-temperature/cryogenic liquid-storage structure comprising:
an outer bearing wall that is impervious to vapor;
an inner tank liner with walls comprised of conventional low-temperature/cryogenic tank-quality plates with flexible structural members; and
load-bearing insulation between the outer surface of the inner tank liner and the inner surface of the outer bearing wall.

2. A low-temperature/cryogenic liquid-storage structure as recited in claim 1, in which the flexible structural members are arranged vertically.

3. A low-temperature/cryogenic liquid-storage structure as recited in claim 1, in which the flexible structural members are spaced at least about 8′ apart.

4. A low-temperature/cryogenic liquid-storage structure as recited in claim 1, in which at least one of the flexible structural members is disposed between adjacent plates.

5. A low-temperature/cryogenic liquid-storage structure as recited in claim 1, in which at least one of the flexible structural members is formed into one of the plates.

6. A low-temperature/cryogenic liquid-storage structure as recited in claim 1, and further comprising connectors that connect the tank liner to the outer bearing wall and accommodate movement of the liner with respect to the bearing wall.

7. A low-temperature/cryogenic liquid-storage structure as recited in claim 7, in which the connectors are spaced at least about 8′ apart laterally.

8. A low-temperature/cryogenic liquid-storage structure comprising:
an outer bearing wall that is impervious to vapor;
an inner tank liner with walls comprised of conventional low-temperature/cryogenic tank-quality plates that have a thickness of between 1/16″ and ½″ and a surface area of at least 100 square feet, with flexible structural members that have a wall thickness of more at least 1/16″ and are in the form of at least one of the following components:
sections of pipe, sections of tubing, and structural shapes; and
load-bearing insulation between the outer surface of the inner tank liner and the inner surface of the outer bearing wall.

9. A low-temperature/cryogenic liquid-storage structure comprising:
an outer bearing wall that is impervious to vapor;
an inner tank liner that has walls comprised conventional low-temperature/cryogenic tank-quality plates that have a thickness of at least 1/16″, with flexible structural members; and
load-bearing insulation between the outer surface of the inner tank liner and the inner surface of the outer bearing wall.

10. A low-temperature/cryogenic liquid-storage structure as recited in claim 9, in which at least one of the plates has a thickness of between 1/16″ and ½″.

11. A low-temperature/cryogenic liquid-storage structure comprising:
an outer bearing wall that is impervious to vapor;
an inner tank liner that has walls comprised of low-temperature/cryogenic tank-quality plates that have a surface area of at least 100 square feet, with flexible structural members; and
load-bearing insulation between the outer surface of the inner tank liner and the inner surface of the outer bearing wall.

12. A low-temperature/cryogenic liquid-storage structure as recited in claim 11, in which at least one of the plates has a surface area of at least about 200 square feet.

13. A low-temperature/cryogenic liquid-storage structure comprising:
an outer bearing wall that is impervious to vapor;
an inner tank liner that has walls comprised of low-temperature/cryogenic tank-quality plates with flexible structural members that have a wall thickness of more than 1/16″; and
load-bearing insulation between the outer surface of the inner tank liner and the inner surface of the outer bearing wall.

14. A low-temperature/cryogenic liquid-storage structure as recited in claim 13, in which the wall thickness of at least one of the flexible structural members is between 1/16″ and ½″.

15. A low-temperature/cryogenic liquid-storage structure comprising:
an outer bearing wall that is impervious to vapor;
an inner tank liner that has walls comprised of low-temperature/cryogenic tank-quality plates with flexible structural members that are in the form of at least one of the following components:
sections of pipe, sections of tubing, and structural shapes; and
load-bearing insulation between the outer surface of the inner tank liner and the inner surface of the outer bearing wall.
